(19) United States
(12) Patent Application Publication
(10) Pub. No.: US 2008/0026165 A1
(43) Pub. Date: Jan. 31, 2008

(54) Electronic Paint Structure with Thermal Addressing Layer

(75) Inventors: Bart Andre Salters, Karel de Grotelaan (NL); Murray Fulton Gilles, Floralaan Oost (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V, Eindhoven (NL)

(21) Appl. No.: 10/597,826

(22) PCT Filed: Feb. 8, 2005
(86) PCT No.: PCT/IB05/50499

§ 371 Date: Aug. 9, 2006

Related U.S. Application Data
(60) Provisional application No. 60/543,729, filed on Feb. 11, 2004.

(51) Int. Cl. B41M 5/40; G03G 5/00; G06F 3/045

(52) U.S. Cl. 428/32.65; 345/174; 430/130

(57) ABSTRACT

An electronic paint for an electrophoretic display includes a lower conductive layer, a thermal addressing layer disposed on the lower conductive layer, a layer of electrophoretic ink disposed on the thermal addressing layer, and an upper conductive layer disposed on the electrophoretic ink. Activation of the electrophoretic ink is based on thermal absorption of thermal radiation in a portion of the thermal addressing layer and a bias voltage applied between the upper conductive layer and the lower conductive layer.

This invention relates generally to electrophoretic displays, and more specifically to an electronic paint including electrophoretic ink with thermal activation.

Electrophoretic display media are being developed for large displays such as whiteboards, signage, billboards and wall displays where semi-permanent images are required. Electrophoretic display media, generally characterized by the movement of particles in an applied electric field, can be bi-stable with display elements having first and second display states that differ in at least one optical property such as lightness or darkness of a color. In recently developed electrophoretic displays the display states occur after microencapsulated particles in the electronic ink have been driven to one state or another by an electronic pulse of a finite duration, and the driven state persists after the activation voltage has been removed. Such displays can have attributes of good brightness and contrast, wide-viewing angles, state stability for two or more states, and low power consumption when compared with liquid crystal displays (LCDs). An exemplary electrophoretic display with microcapsules containing either a cellulosic or gel-like internal phase and a liquid phase, or containing two or more immiscible fluids is described in “Process for Creating an Encapsulated Electrophoretic Display,” Albert et al., U.S. Pat. No. 6,067,185 issued May 23, 2000 and “Multi-Color Electrophoretic Displays and Materials for Making the Same,” Albert et al., U.S. Pat. No. 6,017,584 issued Jan. 25, 2000.

Electrophoretic displays are often designed with various layers of electrophoretic and protective materials. An electrophoretic display having a protective electrode is described in “Protective Electrodes for Electrophoretic Displays,” Drzaic et al., International Patent Application No. WO0038001 published Jun. 29, 2000. The protective electrode can be a vapor permeable electrode that is a reticulated electrically conductive structure, such as a metal screen or wire mesh, or a reticulated structure coated or impregnated with a conductive material.

Most currently available electrophoretic displays receive data and are addressed by driving an active matrix, which may be located on the frontside or backside of the display. An example of a rear-addressing display is taught in “Printable Electrode Structures for Displays,” Comiskey et al., U.S. Pat. No. 6,177,921 issued Jan. 23, 2001. One embodiment of the display combines display materials with silicon transistor addressing structures. Active-matrix driving, however, is not an attractive option for inexpensive billboard-like displays, which require only a low to extremely low refresh rate. Electronic-ink systems have been proposed for large electrophoretic displays that have no intrinsic addressing schemes such as fixed coordinates on a pixel-by-pixel grid to accurately write text and graphics. Researchers are also working on applying this digital or electronic-ink technology to a large electronic wall display of a so-called electronic wallpaper, poster or wall screen, which could consist of a thin electrophoretic film placed on a wall.

An electrophoretic display that is addressable using an external stylus device is described in “Tiled Displays,” Albert et al., U.S. Pat. No. 6,252,564 granted Jun. 26, 2001. A process for creating an electronically addressable display includes multiple printing operations, similar to a multi-color process in conventional screen-printing. The system includes one or more antennae, passive charging circuitry, an active control system, a display, and an energy storage unit.

A paper-like medium that also employs electrophoretic particles preferably non-fluid at room temperature and fluidic at higher temperatures is described in “Image Recording Medium, Image Recording/Erasing Device, and Image Recording Method,” Masato et al, International Patent Application WO0043835 published Dec. 12, 2001.

A method for addressing an electrophoretic display with a photoconductive layer is proposed in “Electrophoretic Displays in Portable Devices and Systems for Addressing such Displays,” Zehner et al., U.S. Patent Application No. 2003/0011868 published Jan. 16, 2003. Where the photoconductive layer is struck by light from the light-emitting layer of the display, the impedance of the photoconductive layer is lowered and the electrophoretic layer may be addressed by an applied electric field to write an image.

While smaller electrophoretic displays often receive data and are addressed by driving an active matrix of the display, large electrophoretic displays may have no intrinsic addressing schemes to accurately write text and graphics. Various methods, systems and related devices have been proposed for externally addressing electrophoretic displays, yet their slow addressing speeds continue to be a challenge. The relatively slow switching speeds of many electrophoretic displays result in an external addressing device being able to transfer image data to the electrophoretic display much more quickly than the time that is necessary for the electrophoretic material to be switched to the correct display state. Consequently, an improved electrophoretic display system would allow the electronic ink to transition to the desired optical state while the external addressing device is moved elsewhere or removed from the display surface.

Therefore, what is needed is a system and process whereby the effective addressing time for an externally addressed electrophoretic surface is increased, and the electrophoretic display can continue to switch from one display state to another after the external addressing device has moved from one area of the electrophoretic surface to another in the process of transferring image data. More particularly, an improved addressing scheme for a larger display would allow rapid strokes of a handheld activation device over the display surface while accommodating the relatively slow transition times of electronic inks. Thus, the display could receive data from a handheld writing device in a short period of time while allowing the electronic paint or ink to switch its display state more slowly. Such a desirable system would be cost effective for large area applications where data is updated infrequently, and its associated methods would be time effective.

One form of the present invention is an electronic paint for an electrophoretic display. The electronic paint includes a lower conductive layer, a thermal addressing layer disposed on the lower conductive layer, a layer of electrophoretic ink disposed on the thermal addressing layer, and an upper conductive layer disposed on the electrophoretic ink. Activation of the electrophoretic ink is based on thermal absorption of thermal radiation in a portion of the thermal addressing layer and a bias voltage applied between the upper conductive layer and the lower conductive layer.

Another form of the present invention is a method of activating an electronic paint. A bias voltage is applied between an upper conductive layer and a lower conductive layer of the electronic paint. Thermal radiation is received on a portion of a thermal addressing layer. At least a portion of the received thermal radiation is absorbed in the portion of the thermal addressing layer, and electrophoretic ink is activated based on the absorbed thermal radiation and the applied bias voltage.

Another form of the present invention is an electronic paint activation system including an electronic brush and an electronic paint. The electronic brush includes a laser scanner and a position detector. The electronic paint includes a lower conductive layer, a thermal addressing layer disposed on the lower conductive layer, a layer of electrophoretic ink disposed on the thermal addressing layer, and an upper conductive layer disposed on the electrophoretic ink. Activation of the electrophoretic ink is based on thermal absorption of thermal radiation from the electronic brush into a portion of the thermal addressing layer and a bias voltage applied between the upper conductive layer and a lower conductive layer of the electronic paint.

The aforementioned forms as well as other forms and features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

With thermal addressing layer 22, faster pulses or scanned beams of light can be used to control the activation of electrophoretic ink 24 to a desired optical state, even if activation occurs at a slower time scale than the scanning process. The heated thermal addressing layer provides a short-term storage effect to allow the scanned beam of light to move elsewhere while the image continues to form into electrophoretic ink 24.

Thermal addressing of electronic paint 10 allows the writing of an image onto an electrophoretic display having electronic paint 10 with, for example, a portable brush or handheld device that locally heat up portions of electronic paint 10 as it moves over electronic paint 10. The area where thermal addressing layer 22 is locally heated becomes more electrically conductive. Thus, when a bias voltage is applied across upper conductive layer 26 and lower conductive layer 20, a larger electric field is generated across the heated region of electrophoretic ink 24 than across the surrounding cooler areas. The larger electric field causes transitions from one optical state to another of electrophoretic ink 24, and while the bias voltage is applied and portions of thermal addressing layer 22 are warm, pixel segments of electronic paint 10 are switched to the desired optical state. For example, electrophoretic ink 24 may be switched from white to black as thermal radiation is applied and absorbed. In another example, an initially black optical state is switched controllably to a gray or white state. In another example, a white optical state is switched to a gray-scale optical state based on the amount of thermal energy absorbed in the thermal addressing layer 22 and the level of the bias voltage. In yet another example, colored electrophoretic ink switches from one color to another based on the bias voltage and the thermal absorption of the applied thermal radiation. After writing and bias voltages are removed, electrophoretic displays incorporating electronic paint 10 continue to be viewable with no additional power consumption.

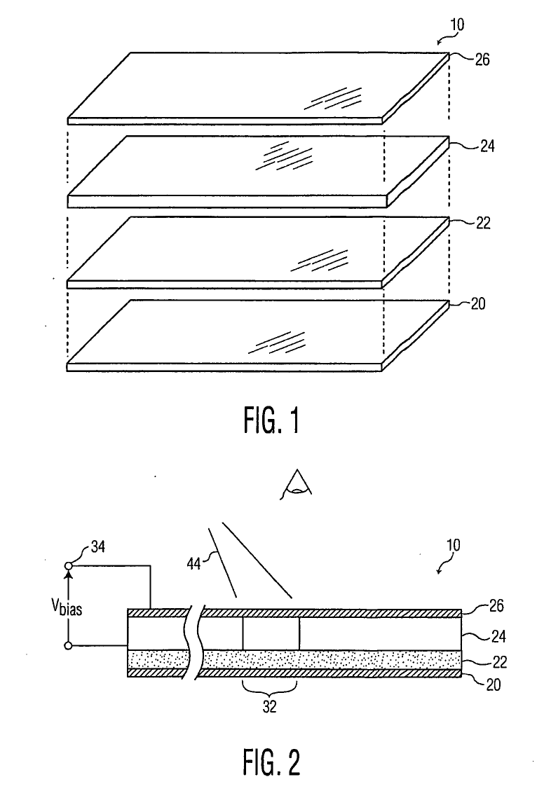

Referring to FIG. 2, electronic paint 10 again includes lower conductive layer 20, thermal addressing layer 22 disposed on lower conductive layer 20, a layer of electrophoretic ink 24 disposed on thermal addressing layer 22, and upper conductive layer 26 disposed on electrophoretic ink 24. Layers in the stack may be formed sequentially where, for example, thermal addressing layer 22 is deposited or applied to lower conductive layer 20 and electrophoretic ink 24 is then applied onto thermal addressing layer 22, and then upper conductive layer 26 is deposited or otherwise applied to electrophoretic ink 24. For example, thermal addressing layer 22 may be sputtered or evaporated onto lower conductive layer 20. Alternatively, electrophoretic ink 24 and thermal addressing layer 22 may be formed separately and laminated together, then coated with thin transparent electrode materials or metal to provide conductive surfaces for electric field generation. Since no patterning or masking is required, electronic paint 10 may be formed in other sequences with process steps such as rolling, screening, or depositions in any suitable order. Sections or tiles of electronic paint 10 of various sizes may be assembled together or placed side-by-side to form electrophoretic displays of nearly any desired size that can be mounted, for example, on walls or other large surfaces. Electronic paint 10 may be formed with a size, for example, of a few centimeters on a side to as large as one meter by one meter or larger.

In an exemplary embodiment of electronic paint 10, images are viewed through transparent upper conductive layer 26, although other embodiments allow backside viewing of or transmissive viewing through electronic paint 10. Reflected displays comprising electronic paint 10 with a metallic backing are viewed from the top, as illustrated. Alternatively, electronic paint 10 may be viewed through lower conductive layer 20, and can be thermally addressed from its backside. In configurations such as a transmissive display, lower conductive layer 20 and thermal addressing layer 22 are transparent over the visible light range and electrophoretic ink 24 is selectively absorbent, allowing backside viewing of written images or optional backlighting of the display.

Image data including text, graphics, drawings or photos may be written onto electronic paint 10 by scanning thermal radiation from a scanned laser beam onto a surface of electronic paint 10. In an exemplary electronic-paint display, incident radiation transmits through upper conductive layer 26 and electrophoretic ink 24, strikes thermal addressing layer 22, and is absorbed into thermal addressing layer 22 to locally heat electronic paint 10. Activation of electrophoretic ink 24 is based on thermal absorption of thermal radiation 44 in a portion 32 of thermal addressing layer 22 and on a bias voltage 34 applied between upper conductive layer 26 and lower conductive layer 20. As thermal addressing layer 22 heats up, the voltage drop across thermal addressing layer 22 lowers while the voltage drop across electrophoretic ink 24 is raised. The increased electric field across electrophoretic ink 24 and the elevated temperature of electrophoretic ink 24 increase the rate at which the ink will switch, allowing pixel segments of electronic paint 10 to be written in a prescribed manner. As thermal addressing layer 22 cools, electrophoretic ink 24 continues to transition to an intended display state as long as bias voltage 34 is applied. The desired optical state of electrophoretic ink 24 can be locked in or frozen by cooling thermal addressing layer 22, by removing bias voltage 34, or both.

Lower conductive layer 20 comprises, for example, a reflective metal such as aluminum, platinum or chrome, or a transparent electrode material such as indium tin oxide (ITO), a conductive polymer including polyethylenedioxythiophene (PEDOT) doped with polyphenylene sulfide (PPS), or other suitably conductive transparent material. With their concomitant higher thermal conductivity, metals tend to disperse heat more rapidly and to locally spread the image unless they are thin.

Thermal addressing layer 22 comprises a material having a negative temperature coefficient (NTC) of resistance, such as manganese oxide, nickel oxide, cobalt oxide, iron oxide, copper oxide, titanium oxide, a semiconductor material, a doped semiconductor material, or other suitable NTC resistor material. A negative temperature coefficient material has that property that the electrical resistance drops with increasing temperature, with typical values of three to seven percent per degree Kelvin. Elevated temperature of thermal addressing layer 22 results in lower resistance and higher electrical conductivity, therefore less voltage is dropped across the layer. Less voltage across thermal addressing layer 22 results in a higher voltage and therefore a higher electric field across electrophoretic ink 24, causing faster switching in areas of elevated temperatures when compared to that of cooler neighboring regions.

Local temperature increases within thermal addressing layer 22 may be generated with focused thermal radiation from a suitable source. Thermal radiation 44 includes, for example, infrared radiation, visible light, ultraviolet light, or a combination thereof. Thermal radiation 44 may be generated, for example, with a laser within a handheld electronic brush, and directed towards selected portions 32 of electronic paint 10 from a scanner coupled to the electronic brush.

Electrophoretic ink 24 comprises an electrophoretic material such as encapsulated electrophoretic particles that can be rotated by application of an electric field into a desired orientation. The electrophoretic particles orient themselves along the field lines of the applied electric field and can be switched from one optical state to another based on the direction and intensity of the electric field and the time allowed to switch states.

Electrophoretic ink 24 may comprise one of several commercially available electrophoretic inks, commonly referred to as electronic inks or e-ink. The layer of electrophoretic ink 24 comprises, for example, a thin electrophoretic film with millions of tiny microcapsules in which positively charged white particles and negatively charged black particles are suspended in a clear fluid. When a negative electric field is applied to the display, the white particles move to the top of the microcapsule where they become visible to the user. This makes the surface appear white at the top position or surface of the microcapsule. At the same time, the electric field pulls the black particles to the bottom of the microcapsules where they are hidden. When the process is reversed, the black particles appear at the top of the microcapsule, which makes the surface appear dark at the surface of the microcapsule. When the activation voltage is removed, a fixed image remains on the display surface. Electrophoretic ink 24 may contain an array of colored electrophoretic materials selectively positioned above thermal addressing layer 22 to allow the generation and display of colored images.

Before another image is written, the electronic ink of the display material may need to be reset to a well-defined state, such as an all white surface with white particles moved to the top of the microcapsules, prior to re-addressing the ink. This can be accomplished with, for example, sustained application of relatively high voltage between upper conductive layer 26 and lower conductive layer 20 of electronic paint 10 forcing electrophoretic ink 24 into an initialized or reset optical state through the applied electric field, or by applying thermal radiation to heat thermal addressing layer 22 while applying a relatively large bias voltage.

Upper conductive layer 26 comprises, for example, a transparent electrode material such as indium tin oxide for topside viewing purposes. It should be observed that upper conductive layer 26 and lower conductive layer 20 do not need to be patterned or have any active matrix addressing capability. Upper conductive layer 26 is at least transparent to the wavelength of the activation laser light.

A backing layer comprising, for example, a sheet of glass or plastic, may be coupled to lower conductive layer 20 to increase the strength or protection of the display while retaining the desired flexibility of the display surface.

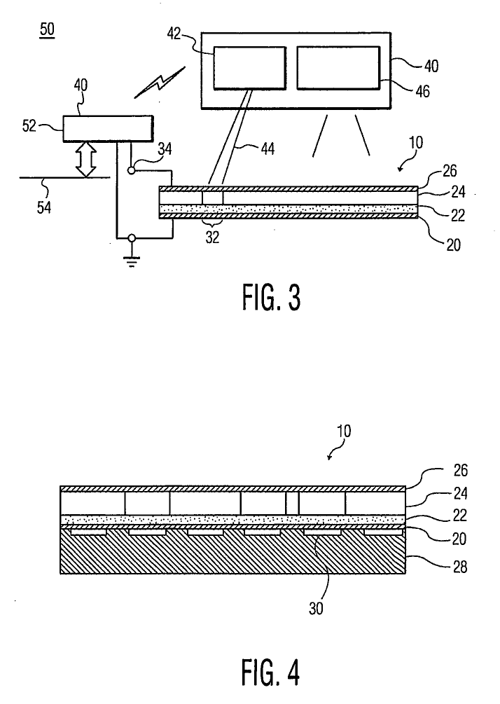

FIG. 3 illustrates an electronic paint activation system 50 including an electronic brush 40 and an electronic paint 10. Electronic brush 40 includes a laser scanner 42 and a position detector 46. Electronic paint 10 includes a lower conductive layer 20, a thermal addressing layer 22, a layer of electrophoretic ink 24, and an upper conductive layer 26. Activation of electrophoretic ink 24 is based on thermal radiation 44 from electronic brush 40 into a portion 32 of thermal addressing layer 22 and a bias voltage 34 applied between upper conductive layer 26 and lower conductive layer 20 of electronic paint 10. With an applied bias voltage 34 and incident thermal radiation 44 directed onto a portion 32 of thermal addressing layer 22, one or more pixels can be written onto electronic paint 10 as desired. Thermal radiation 44 may be generated, for example, from a laser source within electronic brush 40 and directed by laser scanner 42 onto desired portions of electronic paint 10. Position detector 46 provides position input such as location and rotation to accurately write the desired image.

Exemplary electronic paint activation system 50 includes a controller 52 that is electrically coupled to electronic brush 40 and controls thermal radiation 44 from electronic brush 40 along with other initialization and writing functions. Controller 52, such as a microprocessor, a microcontroller, a field-programmable gate array (FPGA), or other digital device may receive and execute microcoded instructions to write a desired image onto electronic paint 10. Controller 52 controls laser scanner 42 and the light striking thermal addressing layer 22 based on a determined position of electronic brush 40.

Controller 52 may be wired or wirelessly connected to electronic brush 40 with a suitable serial or parallel interface. For example, controller 52 can be contained within a personal computer (PC), a laptop computer, or a personal digital assistant (PDA) and connected to electronic brush 40 via a cable or a short-range wireless link such as Bluetooth™ or 802.11 protocols. Alternatively, controller 52 is contained within electronic brush 40, and image data is provided to electronic brush 40 and controller 52 via a memory device such as a memory stick, or an uplink from a PC, laptop computer or PDA that is optionally connected to the communication network 54. Controller 52 may be connected to a communications network 54 such as a local area network (LAN), a wide-area network (WAN), or the Internet to receive and send information to activate and transfer images onto electronic paint 10.

As electronic brush 40 is stroked or swept across the surface of electronic paint 10, thermal radiation 44 from laser scanner 42 is directed preferentially at portions of thermal addressing layer 22 to write the image data. Bias voltage 34 may be set to a fixed level as laser scanner 42 thermally addresses electronic paint 10. Alternatively, bias voltage 34 maybe continuously varied as thermal radiation 44 from laser scanner 42 is scanned across the surface of electronic paint 10, while position detector 46 provides sensor information that allows controller 52 to determine the location and rotation of electronic brush 40. The image data can be provided in real time as the image is written with electronic brush 40, or stored within electronic brush 40 until written.

In one embodiment, a backing layer such as a sheet of plastic or a sheet of glass is coupled to lower conductive layer 20, offering desirable rigidity and ruggedness, and helping to thermally insulate image pixels and pixel segments from neighboring pixels.

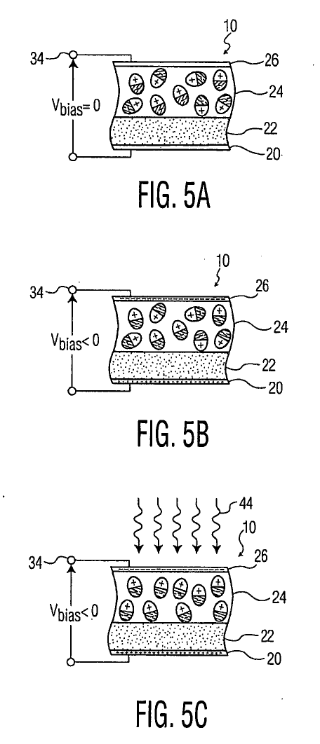

FIG. 4 shows a cross-sectional view of an electronic paint with a thermal addressing layer and a backing layer, in accordance with one embodiment of the present invention. Electronic paint 10 includes a lower conductive layer 20, a thermal addressing layer 22 disposed on lower conductive layer 20, a layer of electrophoretic ink 24 disposed on thermal addressing layer 22, and an upper conductive layer 26 disposed on electrophoretic ink 24. A backing layer 28 is coupled to lower conductive layer 20. Backing layer 28 comprises, for example, a sheet of plastic, a sheet of glass, a sheet of metal such as aluminum, copper or a metal alloy, or a ceramic substrate. Backing layer 28 may contain an array of recessed regions 30 to thermally isolate pixel segments in the layer of electrophoretic ink 24. As electronic paint 10 is thermally addressed, portions of thermal addressing layer 22 are locally heated above one or more recessed regions 30 and electrophoretic particles within electrophoretic ink 24 are switched to the desired optical state accordingly. Thermal isolation of pixel segments allows faster switching, higher contrast, and less bleeding of an image into neighboring regions. Recessed regions 30 and the perimeter region may be sized to provide a desired time constant for heating and cooling thermal addressing layer 22 and to provide the desired latency time for switching electrophoretic ink 24. Backing layer 28 may be glued, adhered, or otherwise attached to lower conductive layer 20 of electronic paint 10.

Recessed regions 30 may be configured with small, locally isolated points or regions. In one example, the size of recessed regions 30 is on the order of the pixel size for the display. In another example, the size of recessed regions 30 is appreciably smaller than the pixel size for the display, such that more than one recessed region 30 is irradiated with thermal radiation from an applied laser beam to activate electrophoretic ink 24. The array of recessed regions may be configured to encompass, for examples: an array of magenta, yellow, and cyan electrophoretic materials; an array of magenta, yellow, cyan and black electrophoretic materials; or an array of red, green and blue electrophoretic materials for transmissive displays.

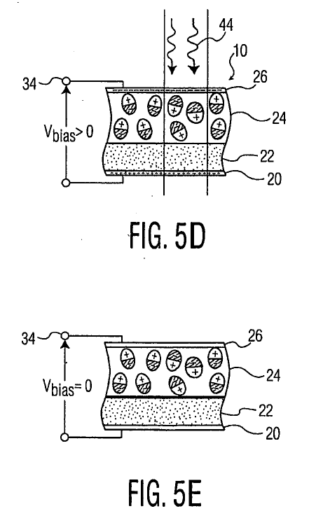

FIG. 5A, FIG. 5B, FIG. 5C, FIG. 5D and FIG. 5E are illustrations of a method for activating an electronic paint having a thermal addressing layer, in accordance with one embodiment of the present invention. An electronic paint 10 including a lower conductive layer 20, a thermal addressing layer 22, a layer of electrophoretic ink 24, and an upper conductive layer 26 is exposed to various bias voltages 34 and focused thermal radiation to control and switch portions of electronic paint 10. These cross-sectional views show electronic paint 10 under various electrical and thermal influences.

In an initial state seen in FIG. 5a, electrophoretic particles of electrophoretic ink 24 are randomly oriented resulting in, for example, a gray or medium-colored background. Alternatively, electrophoretic ink 24 may have a previously written image stored on it. Bias voltage 34 is set to zero or connections to an external voltage supply are simply disconnected.

Bias voltage 34 is applied across upper conductive layer 26 and lower conductive layer 20. In the step illustrated in FIG. 5b, a negative bias voltage is applied. Due to the high electrical resistivity of thermal addressing layer 22 and a small electric field across electrophoretic ink 24, the electrophoretic particles in electrophoretic ink 24 remain predominantly in their initial optical state.

When thermal radiation 44 impinges onto electronic paint 10 and bias voltage 34 is applied to upper conductive layer 26 and lower conductive layer 20, portions or all of thermal addressing layer 22 heat up. This results in a lower electrical resistance in thermal addressing layer 22 and a higher electric field across electrophoretic ink 24, thereby causing electrophoretic particles within electrophoretic ink 24 to re-orient into an initialized optical state such as a white state, as shown in FIG. 5c. An incident beam of light or thermal radiation 44 is absorbed in a portion of thermal addressing layer 22, and a more conductive path is generated between lower conductive layer 20 and electrophoretic ink 24. As the local conductivity is increased in thermal addressing layer 22, the electric field generated across electrophoretic ink 24 increases and electrophoretic ink 24 is driven accordingly. Even when electronic paint 10 is no longer exposed to thermal radiation 44, the electrophoretic particles in electrophoretic ink 24 continue their path towards their desired orientation.

Bias voltage 34 and incident thermal radiation 44 are then removed and electrophoretic ink 24 remains in the initialized optical state until written upon. When the bias voltage has been removed from electronic paint 10, the electrophoretic particles in electrophoretic ink 24 stabilize and are locked into a desired optical state.

As illustrated in FIG. 5d, positive bias voltage 34 is applied across electronic paint 10. Thermal radiation 44 is focused and applied to portion 32 of electronic paint 10. The incident radiation is partially or fully absorbed into portion 32 of thermal addressing layer 22. Additionally, some of the incident radiation may be absorbed directly into portion 32 of electrophoretic ink 24 and contribute to the local heating of thermal addressing layer 22. Electrophoretic particles in portion 32 of electrophoretic ink 24 switch optical states to produce, for example, a black pixel with white electrophoretic paint in neighboring areas.

When bias voltage 34 has been removed and thermal addressing layer 22 has cooled, the electrophoretic particles of electrophoretic ink 24 become frozen in their intended optical states, as seen in FIG. 5e. The polarity of bias voltages, the color of electronic ink, the thickness of the various layers, and the aspect ratio for writing an individual pixel have been chosen to be illustrative and instructive. The bias voltages, the color of electronic ink, the actual thickness of the materials, and the pixel size may vary appreciably from that shown without departing from the spirit and scope of the claimed invention.

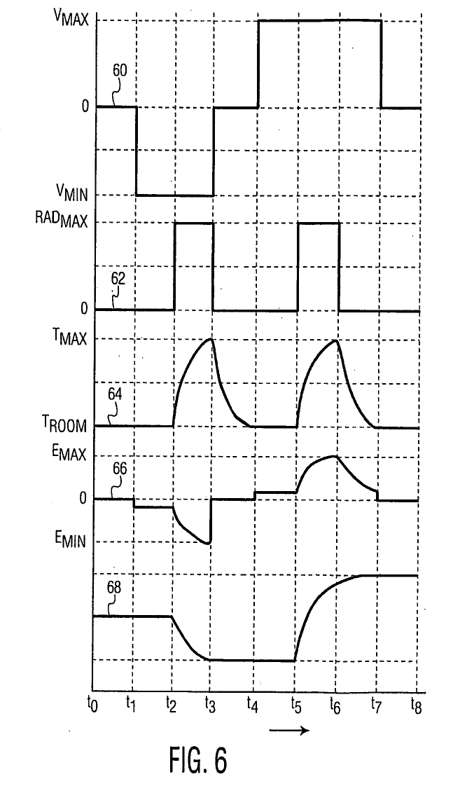

FIG. 6 shows a graphical representation of exemplary changes in bias voltage, thermal radiation, temperature, electric field and ink color when an electronic paint with a thermal addressing layer is activated, in accordance with one embodiment of the present invention. Bias voltage signal 60 represents the bias voltage applied to the electronic paint. Thermal radiation intensity 62 represents the thermal radiation applied to a portion or all of the electronic paint. Temperature curve 64 is the temperature of a portion of the addressing layer exposed by the incident thermal radiation. Electric field intensity 66 represents the electric field across a portion of the electrophoretic ink as various bias voltages and incident thermal radiation are applied and removed. Ink color curve 68 represents color or optical states of the electrophoretic ink as bias voltage and incident thermal radiation are applied. The timing, magnitude and polarity of applied voltages, and thermal time constants for the materials in the electronic paint are intended to be illustrative, and may vary greatly from the representation shown.

At time t=t₀, the electronic paint is in a dormant or a previously written state. The bias voltage is zero, and no thermal radiation from a scanned source is being applied. The temperature of the electronic paint is at an ambient or room temperature and there is no electric field across the electrophoretic ink. The electrophoretic ink remains in its initial state, shown by ink color curve 68 as a mid-tone gray optical state.

At time t=t₁, a negative bias voltage is applied to the upper conductive layer with respect to the lower conductive layer. The negative bias may be on the order of, for example, −5 to −15 volts. Thermal radiation is not applied, and the temperature of the electrophoretic ink remains at ambient temperature with other portions of the electronic paint. A small electric field occurs across the electrophoretic ink, though little, if any transition takes place.

At time t=t₂, incident thermal radiation is applied to a portion or all of the electronic paint. The thermal addressing layer heats up, decreasing the electrical resistance and increasing the electric field across the electrophoretic ink. The color or optical state of the electrophoretic ink changes according to the bias voltage and the temperature of the thermal addressing layer; and according to the time at which the bias voltage is applied and the thermal addressing layer stays at an elevated temperature. In the example shown, the electrophoretic ink is switched from its current gray state to a white state. When the electrophoretic ink has reached the switched state, further changes do not occur even with continued application of bias voltage and heating of the addressing layer.

At time t=t₃, the bias voltage and the incident thermal radiation are removed. The electric field across the electrophoretic ink drops to zero and the thermal addressing layer cools back to room temperature. The electrophoretic ink remains in its initialized, all-white state.

At time t=t₄, a positive bias voltage is applied, generating a small electric across the electrophoretic ink while causing little or no optical state transitions.

At time t=t₅, a portion of the electronic paint is thermally addressed and heated up, increasing the local temperature of the thermal addressing layer and increasing the electric field across the electrophoretic ink. The electrophoretic ink in the vicinity of the heated thermal addressing layer switches optical state, such as to a completely black optical state as shown. As the thermal radiation is removed and directed elsewhere, the optical state of the electrophoretic ink may continue to switch, if its predetermined state has not yet been reached.

At time t=t₆, the thermal radiation is removed and the thermal addressing layer cools down. The electric field across the electrophoretic ink drops, and the optical state of the electrophoretic ink may continue to transition until its predetermined state is reached. Ink color curve 68 indicates that the electrophoretic ink can continue to re-orient or “develop” after the incident light or thermal radiation is removed.

At time t=t₇, the bias voltage is set to zero or disconnected. The electric field across the electrophoretic ink drops to zero, and further transitions of the electrophoretic ink are curtailed. The color and intensity of the electrophoretic ink are locked in or frozen.

At time t=t₈, the electronic paint remains in its intended optical state, preserving the written image until refreshed, re-initialized, or written over by subsequent addressing of the electrophoretic ink.

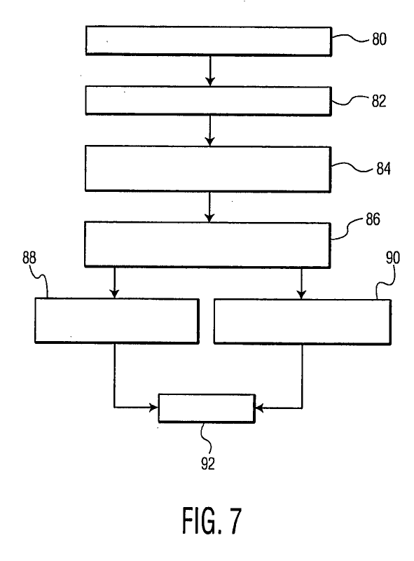

FIG. 7 is a flow diagram of a method for activating an electronic paint. Various steps are described to initialize and activate an electronic paint, such as the exemplary electronic paint shown in FIG. 2.

The electrophoretic ink is initialized to an initialized optical state, as seen at block 80. The electrophoretic ink may be initialized, for example, to an all-white, an all-black optical state, or to a colored optical state depending on the type of electrophoretic ink and the applied bias voltage. Initialization of the electrophoretic ink is accomplished, for example, with application of a negative bias voltage and flooding or sweeping the electronic paint with thermal radiation to switch the electrophoretic particles within the electrophoretic ink to the initialized state. From this first optical state, the electrophoretic can be adjusted in one common direction based on the driving forces applied to the electrophoretic ink. The electronic paint may be stored in the initialized state for an indeterminate period of time or written upon forthwith.

To write on the electronic paint, a bias voltage is applied, as seen at block 82. The bias voltage is applied between an upper conductive layer and a lower conductive layer of the electronic paint. The bias voltage may be a fixed positive voltage or a fixed negative voltage. Alternatively, the bias voltage may vary in voltage level based on the image data and the position of a scanned beam of laser light so that the driving force on the electrophoretic ink is controlled.

Thermal radiation is received on a portion of the thermal addressing layer, as seen at block 84. Thermal radiation is received, for example, from a laser scanner that projects and directs thermal radiation such as infrared, visible, or ultraviolet light to locally heat portions of the thermal addressing layer. At least a portion of the received thermal radiation is absorbed in the portion of the thermal addressing layer. As light energy is absorbed, an electrically conductive path is generated through the thermal addressing layer, between the lower conductive layer and the layer of electrophoretic ink. Other portions of the received thermal radiation may be absorbed into the electrophoretic ink, locally heating the electrophoretic ink and the underlying thermal addressing layer and further aiding in the transition to the desired optical state.

The thermal radiation may be received from a scanned beam of laser light from an electronic brush. The electronic brush includes, for example, a laser scanner and one or more position detectors. The location and rotation of the electronic brush is determined with detector signals from the position detectors. The laser scanner is actuated to direct laser light from the electronic brush onto the electronic paint so that an image may be transferred.

The electrophoretic ink is activated based on the absorbed thermal radiation and the applied bias voltage, as seen at block 86. Increasing the local temperature of the thermal addressing layer lowers the voltage drop across the thermal addressing layer and increases the voltage drop and electric field across the electrophoretic ink to switch the optical state of the electrophoretic ink to the desired state. A larger bias voltage will increase the switching time of the electrophoretic ink. An optical state of at least a portion of the electrophoretic ink is set while the electrophoretic ink is activated. Until the addressing layer is cooled or the bias voltage is removed, the electrophoretic ink may continue to switch until the desired optical state is reached.

The bias voltage is removed and the electrophoretic ink stabilizes in a predetermined optical state with the removal of the bias voltage, as seen at block 88. Transitions of the electrophoretic ink may be abruptly slowed or halted by removal of the bias voltage, thereby storing the written image, even as the thermal addressing layer is cooled.

Alternatively, the thermal addressing layer cools and the electrophoretic ink stabilizes in a predetermined optical state based on the cooling of the thermal addressing layer, as seen at block 90. Even as the electronic brush or other thermal activator moves away from the heated portion of the thermal addressing layer, the heated portion of the thermal addressing layer may continue to switch the electrophoretic ink as it cools. If the cooling is too rapid, heat may be dissipated to quickly and the electrophoretic ink incompletely switched. To assist in controlled cooling of the thermal addressing layer, the backing layer of the electronic paint may include an array of recessed regions to thermally isolate pixel segments in the layer of electrophoretic ink.

In one embodiment, the brief exposure of the thermal addressing layer to incident thermal radiation rapidly and fully switches the electrophoretic ink in the vicinity of the heated thermal radiation layer. In another embodiment, the degree of incident thermal radiation and the cooling rate are controlled to allow the electrophoretic ink to reach an intermediate state in a controlled manner even after the source of the incident thermal radiation has moved away from the heated area.

To write image data to all portions of the electronic paint, the steps for activating one portion can be performed in series, in parallel, or some combination thereof with the steps for activating another portion of the electronic paint so that the optical state of each portion is set at the desired level. In an electronic-paint system having an electronic brush, for example, the image data is written onto additional portions of the electronic paint as the electronic brush is moved across the surface of the electronic paint or is lifted from the surface and new strokes are started.

When the desired image has been transferred to the electronic paint, the image may be viewed as seen at block 92. Further refreshing or writing of new images may occur as desired within, for example, minutes, hours, days, weeks or even months after transferring the first image.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An electronic paint for an electrophoretic display, said electronic paint comprising:
a lower conductive layer;
a thermal addressing layer disposed on the lower conductive layer;
a layer of electrophoretic ink disposed on the thermal addressing layer; and
an upper conductive layer disposed on the electrophoretic ink,
wherein activation of the electrophoretic ink is based on thermal absorption of thermal radiation in a portion of the thermal addressing layer and a bias voltage applied between the upper conductive layer and the lower conductive layer.

2. The electronic paint of claim 1, wherein the lower conductive layer includes one of a reflective metal and a transparent electrode material.

3. The electronic paint of claim 1, wherein the thermal addressing layer is selected from the group consisting of manganese oxide, nickel oxide, cobalt oxide, iron oxide, copper oxide, titanium oxide, a semiconductor material, a doped semiconductor material, and a negative temperature coefficient material, the thermal absorbing layer having a negative temperature coefficient of resistance.

4. The electronic paint of claim 1, wherein the thermal radiation includes one of infrared radiation, visible light, and ultraviolet light.

5. The electronic paint of claim 1, further comprising:
a backing layer coupled to the lower conductive layer.

6. The electronic paint of claim 5, wherein the backing layer includes one of a sheet of plastic or a sheet of glass.

7. The electronic paint of claim 5, wherein the backing layer includes an array of recessed regions to thermally isolate pixel segments in the layer of electrophoretic ink.

8. The electronic paint of claim 1, wherein the upper conductive layer includes a transparent electrode material.

9. A method of activating an electronic paint, the method comprising:
applying a bias voltage;
receiving thermal radiation on a portion of a thermal addressing layer;
absorbing at least a portion of the received thermal radiation in the portion of the thermal addressing layer, and
activating an electrophoretic ink based on the absorbed thermal radiation and the applied bias voltage.

10. The method of claim 9, wherein the bias voltage is applied between an upper conductive layer and a lower conductive layer of the electronic paint.

11. The method of claim 9, wherein the received thermal radiation includes one of infrared radiation, visible light, and ultraviolet light.

12. The method of claim 9, wherein receiving thermal radiation on the portion of the thermal addressing layer includes:
receiving thermal radiation from a scanned beam of laser light from an electronic brush.

13. The method of claim 9, further comprising:
setting an optical state of at least a portion of the electrophoretic ink while the electrophoretic ink is activated.

14. The method of claim 9, further comprising:
removing the bias voltage; and
stabilizing the electrophoretic ink in a predetermined optical state responsive to the removal of the bias voltage.

15. The method of claim 9, further comprising:
cooling the thermal addressing layer; and
stabilizing the electrophoretic ink in a predetermined optical state based on the cooling of the thermal addressing layer.

16. The method of claim 9, further comprising:
initializing the electrophoretic ink to an initialized optical state.

17. An electronic paint activation system, comprising:
an electronic brush including a laser scanner and a position detector; and
an electronic paint including a lower conductive layer, a thermal addressing layer disposed on the lower conductive layer, a layer of electrophoretic ink disposed on the thermal addressing layer, and an upper conductive layer disposed on the electrophoretic ink,
wherein activation of the electrophoretic ink is based on thermal absorption of thermal radiation from the electronic brush into a portion of the thermal addressing layer and a bias voltage applied between the upper conductive layer and lower conductive layer of the electronic paint.

18. The electronic paint activation system of claim 17, further comprising:
a backing layer coupled to the lower conductive layer.

19. The electronic paint activation system of claim 17, further comprising:
a controller electrically coupled to the electronic brush, wherein the controller controls the thermal radiation from the electronic brush.

20. The electronic paint activation system of claim 19, wherein the controller is wired or wirelessly connected to the electronic brush.
